(19) United States
(12) Patent Application Publication
(10) Pub. No.: US 2004/0260745 A1
(43) Pub. Date: Dec. 23, 2004

(54) Load balancer performance using affinity modification

(76) Inventors: Christopher A. S. Gage, Raleigh, NC (US); Diane P. Pozefsky, Chapel Hill, NC (US); Soumitra Sarkar, Cary, NC (US)

Correspondence Address: Ido Tuchman, Suite 503, 69-60 108th Street, Forest Hills, NY, 11375, US

(21) Appl. No.: 10/464,715

(22) Filed: Jun. 18, 2003

(51) Int. Cl. G06F 15/173; G06F 15/16

(52) U.S. Cl. 709/200; 709/225; 718/105

(57) ABSTRACT

A method, system, and computer program for managing network connectivity between a host and a server cluster. The invention helps reduce network traffic bottlenecks at the server cluster by instructing the host to modify its network mapping such that messages sent by the host to the server cluster reach a selected server cluster member without passing through a dispatching node.

### FIELD OF THE INVENTION

The present invention relates generally to computer networks, and more specifically to management of network connectivity between a host and server cluster members in a clustered network environment.

### BACKGROUND

A computer network is a collection of computers, printers, and other network devices linked together by a communication system. Computer networks allow devices within the network to transfer information and commands between one another. Many computer networks are divided into smaller “sub-networks” or “subnets” to help manage the network and to assist in message routing. A subnet generally includes all devices in a network segment that share a common address component. For example, subnet can be composed of all devices in the network having an IP (Internet Protocol) address with the same subnet identifier.

Some network systems utilize server clusters, also called computer farms, to handle various resources in the network. A server cluster distributes work among its cluster members so that no one computer (or server) becomes overwhelmed by task requests. For example, several computers may be organized as members in a server cluster to handle an Internet site's Web requests. Server clusters help prevent bottlenecks in a network by harnessing the power of multiple servers.

Generally, a server cluster includes a load balancing node that keeps track of the availability of each cluster member and receives all inbound communications to the server cluster. The load balancing node systematically distributes tasks among the cluster members. When a client or host (i.e., a computer) outside the server cluster initially submits a request to the server cluster, the load balancing node selects the best-suited cluster member to handle the message. The load balancing node then passes the request to the selected cluster member and records the selection in an “affinity” table. In this context, the affinity is a relationship between the network addresses of the client and (selected) server, as well as subaddresses that identify the applications on each. Such an affinity might be established irrespective of whether the underlying network protocol supports connection-oriented (as in Transmission Control Protocol, or TCP) or connectionless (User Datagram Protocol, or UDP) service.

Once such an affinity is established between the client and the cluster member, all future communications identifying the established connection are sent to the same cluster member using the connection table until the affinity relationship is to be removed. For connectionless (e.g., UDP) traffic, the duration of the relationship can be based on a configured timer value—e.g., after 5 minutes of inactivity between the client and the server applications the affinity table entry is removed. For connection-oriented (e.g., TCP) traffic, the affinity exists as long as the network connection exists, the termination of which can be recognized by looking for well-defined protocol messages.

In load balancing nodes (e.g., IBM's Network Dispatcher), such affinity configuration is typical for UDP packets from a given host to the cluster IP address, and a given target port identifying a “service” (e.g., Network File System (NFS) V2/V3). In the NFS case, if there is a cluster of servers serving NFS requests, it is beneficial to direct all UDP requests for NFS file services from a given host (NFS client) to a given server (running NFS server software) in the cluster because even though UDP is a stateless (and connectionless) protocol, the given server in the cluster might accumulate state information specific to the host (e.g., NFS lock information handed to the NFS client running on that host) such that directing all NFS traffic from that host to the same server would be beneficial from a performance point of view. Since UDP is connectionless, when to break the affinity between the host and the server in the cluster is determined by a timer that indicates a certain period (e.g., 10 minutes) of inactivity.

In such a load balancing scheme, when a cluster member communicates directly with a client, it identifies itself using its own address instead of the address of the server cluster. Outbound traffic does not go through the load balancing node. The fact that network traffic is being distributed between various servers in the server cluster is invisible to the client. Moreover, to a computer outside the server cluster, the server cluster structure is invisible.

As mentioned above, the implementation of a conventional server cluster model requires that all inbound network traffic travel through the load balancing node before arriving at an assigned server. In many applications, this overhead is perfectly acceptable. The most commonly cited application of server clusters is to load balance HTTP (HyperText Transfer Protocol) requests in a Web server farm. HTTP requests are typically small inbound messages, i.e., a GET or POST request specifying a URL (Universal Resource Locator), and some parameters perhaps. It is usually the HTTP response that is large, such as an HTML (HyperText Markup Language) file and/or an image file sent to a browser. Therefore, conventional server cluster models work well in such applications.

In other applications, however, the conventional server cluster model can be quite burdensome. Requiring that each inbound packet travel through the load balancing node can cause performance bottlenecks at the load balancing node if the inbound messages are large. For example, in file serving applications, such as a clustered NAS (Network Attached Storage) configuration, the size of inbound file write requests can be substantial. In such a case, the overhead of reading an entire write request packet at the load balancing node and then writing the packet back out on a NIC (Network Interface Card) to redirect it to another server can cause a bottleneck on the network, the CPU, or its PCI bus.

### SUMMARY OF THE INVENTION

The present invention addresses the above-mentioned limitations of traditional server cluster configurations when the networking protocol in use is TCP or UDP, each of which operates on top of Internet Protocol (IP). It works by instructing a host communicating with a server cluster to modify its network mapping such that future messages sent by the host to the server cluster reach a selected target server without passing through the load balancing node. Such a configuration bypasses the load balancing node and therefore beneficially eliminates potential bottlenecks at the load balancing node due to inbound host network traffic.

Thus, an aspect of the present invention involves a method for managing network connectivity between a host and a target server. The target server belongs to a server cluster, and the server cluster includes a dispatching node configured to dispatch network traffic to the cluster members. The method includes a receiving operation for receiving an initial message from the host at the dispatching node, where an initial message could be a TCP connection request for a given service (port), or a connectionless (stateless) UDP request for a given port. A selecting operation selects the target server to receive the initial message and a sending operation sends the initial message to the target server. An instructing operation requests the host to modify its network mapping such that subsequent messages sent by the host to the server cluster reach the target server without passing through the dispatching node, until the dispatching node decides to end the client-to-server-application affinity.

Another aspect of the invention is a system for managing network connectivity between a host and a target server. As above, the target server belongs to a server cluster, and the server cluster includes a dispatching node configured to dispatch network traffic to the cluster members. The system includes a receiving module configured to receive network messages from the host at the dispatching node. A selecting module is configured to select the target server to receive the network messages from the host and a dispatching module is configured to dispatch the network messages to the target server. An instructing module is configured to instruct the host to modify its network mapping such that subsequent messages sent by the host to the server cluster reach the target server without passing through the dispatching node, until the dispatching node decides to end the client-to-server-application affinity.

A further aspect of the invention is a computer program product embodied in a tangible media for managing network connectivity between a host and a target server. The computer program includes program code configured to cause the program to receive an initial message from the host at the dispatching node, select the target server to receive the initial message, send the initial message to the target server, and instruct the host to modify its network mapping such that subsequent messages sent by the host to the server cluster reach the target server without passing through the dispatching node, until the dispatching node decides to end the client-to-server-application affinity.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an exemplary network environment embodying the present invention.

FIG. 2 shows one embodiment of messages sent to and from a server cluster in accordance with the present invention.

FIG. 3 shows a high level flowchart of operations performed by one embodiment of the present invention.

FIG. 4 shows an exemplary system implementing the present invention.

FIG. 5 shows a detailed flowchart of operations performed by the embodiment described in FIG. 3.

FIG. 6 shows details of steps 530 and 536 of FIG. 5, as applicable to the ARP broadcast method and the ICMP_REDIRECT methods.

FIG. 7 shows an example of one possible race condition that may occur under the present invention.

### DETAILED DESCRIPTION OF THE INVENTION

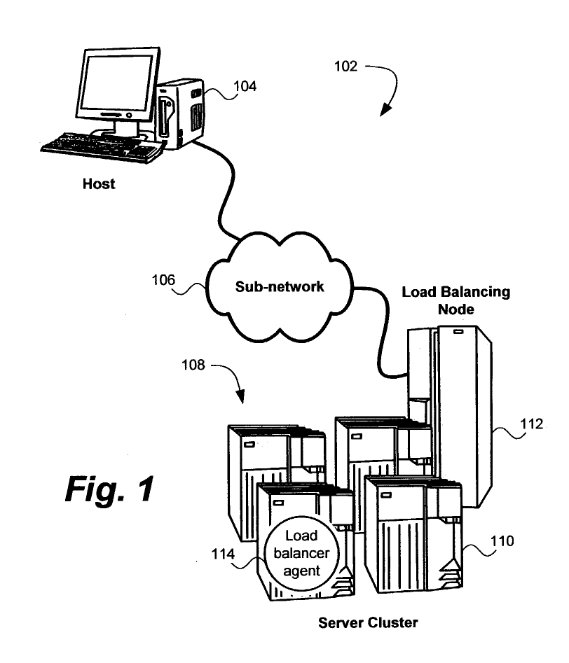

The following description details how the present invention is beneficially employed to improve the performance of traditional server clusters. Throughout the description of the invention reference is made to FIGS. 1-6. When referring to the figures, like structures and elements shown throughout are indicated with like reference numerals.

In FIG. 1, an exemplary network environment 102 embodying the present invention is shown. It is initially noted that the network environment 102 is presented for illustration purposes only, and is representative of countless configurations in which the invention may be implemented. Thus, the present invention should not be considered limited to the system configuration shown in the figure.

The network environment 102 includes a host 104 coupled to a computer subnet 106. The host 104 is representative of any network device capable of modifying its network mapping information according to the present invention, as described in detail below. In one embodiment of the invention, the host 104 is a NAS client.

The subnet 106 is configured to effectuate communications between various nodes within the network environment 102. In a particular embodiment of the invention, the subnet 106 includes all devices in a network environment 102 that share a common address component. For example, the subnet 106 may comprise all devices in the network environment 102 having an IP (Internet Protocol) address that belong to the same IP subnet. The subnet 106 may be arranged using various topologies known to those skilled in the art, such as hub, star, and local area network (LAN) arrangements, and include various communication technologies known to those skilled in the art, such as wired, wireless, and fiber optic communication technologies. Furthermore, the subnet 106 may support various communication protocols known to those skilled in the art. In one embodiment of the present invention, the subnet 106 is configured to support Address Resolution Protocol (ARP) and/or Internet Control Message Protocol (ICMP), each of which runs in addition to TCP, UDP, and IP.

A server cluster 108 is also coupled to the subnet 106. As mentioned above, the host 104 and server cluster 108 are located on the same subnet 106. In other words, network packets sent from the host 104 require no additional router hops to reach the server cluster 108. The server cluster 108 comprises several servers 110 and a load balancing node 112 connected to the subnet 106. As used herein, a server cluster 108 is a group of servers 110 selected to appear as a single entity. Furthermore, as used herein, a load balancing node includes any dispatcher configured to redirect work among the servers 110. Thus, the load balancing node 112 is but one type of dispatching node that may be utilized by the present invention, and the dispatching node may use any criteria, including, but not limited to, workload balancing to make its redirection decisions. The servers 110 selected to be part of the cluster 108 may be selected for any reason. Furthermore, the cluster members may not necessarily be physically located close to one another or share the same network connectivity. Every server 110 in the cluster 108, however, must have connectivity to the load balancing node 112 and the subnet 106. It is envisioned that the server cluster 108 may contain as many servers 110 as required by the system to deal with average as well as peak demands from hosts.

Each server 110 in the cluster 108 may include a load balancer agent 114 that talks to the load balancing node 112. Typically, these agents 114 provide server load information to the load balancer 112 (including infinite load if the server 110 is dead, and the agent 114 is not responding) to allow it to make intelligent load balancing decisions. As discussed in more detail below, the agent 114 may also perform additional functions such as monitoring when the number of TCP connections initiated by a host 104 goes to 0, to allow the load balancer 112 to regain control of the dispatching TCP connections to the server cluster IP address. The same is the case with UDP traffic, since the individual servers 110 and agents 114 must monitor when there has been sufficient amount of inactivity of UDP traffic from the host 104 to allow the load balancing node 112 to regain control of dispatching UDP datagrams sent to the cluster IP address.

Typically, the server cluster 108 is a collection of computers designed to distribute network load among the cluster members 110 so that no one server 110 becomes overwhelmed by task requests. The load balancing node 112 performs load balancing functions in the server cluster 108 by dispatching tasks to the least loaded servers in the server cluster 108. The load balancing is generally based on a scheduling algorithm and distribution of weights associated with cluster members 110. In one configuration of the present invention, the server cluster 108 utilizes a Network Dispatcher developed by International Business Machines Corporation to achieve load balancing. It is contemplated that the present invention may be used with other network load balancing nodes, such as various custom load balancers.

In a particular embodiment of the invention, the server cluster 108 is configured as a NAS (Network-Attached Storage) server cluster. As mentioned above, conventional server clusters configured as clustered NAS servers are prone to network traffic bottlenecks at the load balancing node 112 because the size of inbound network packets can be quite large when file system write operations are involved. As discussed in detail below, the present invention overcomes such bottlenecks by instructing the host 104 to modify its network mapping such that future messages sent by the host 104 to the server cluster 108 reach a selected target server without passing through the load balancing node 112. Such a configuration bypasses the load balancing node 112 and therefore beneficially eliminates potential bottlenecks at the load balancing node 112.

While the network configuration of FIG. 1 describes the host 104 and server cluster 108 as being on the same subnet 106, this is a typical and very useful real-world configuration. For example, servers such as Web servers or databases that use a cluster of Network Attached Storage devices (supporting file access protocols like NFS and CIFS) often reside in the same IP subnet of a data center environment. For the clustered NAS to function in high availability mode, load balancing is typically performed. Thus, the present invention allows the overhead of the load balancing node to be alleviated in very common network configurations.

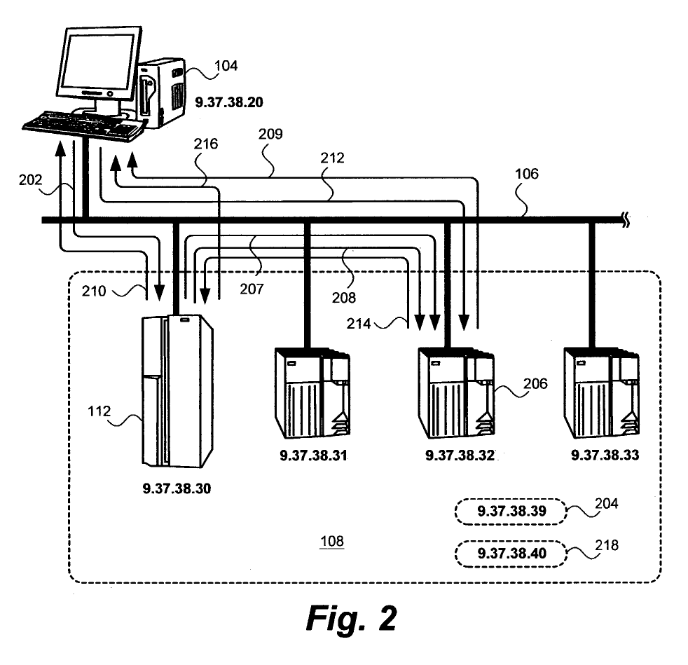

Referring now to FIG. 2, one embodiment of messages sent to and from the server cluster 108 is shown. In accordance with this embodiment, an initial message 202 is transmitted from the host 104 to the server cluster 108. It is noted that the initial message 202 may not necessarily be the first host message in network session between the host 104 to server cluster 108 and may include special information or commands, as discussed below. In general, the initial message 202 is either a TCP connection request or UDP datagram intended for the server cluster's virtual IP address 204. A virtual IP address is an IP address selected to represent a cluster or service provided by a cluster, which does not map uniquely to a single box. The initial message 202 includes a destination port (TCP or UDP) that identifies which application is being accessed in the server cluster 108.

The cluster's virtual IP address 204 is mapped to the load balancing node 112 so that the initial message 202 arrives at the load balancing node 112. As mentioned above, the host 104, the server cluster 108, and the cluster members are all located on the same subnet 106. Thus, each device on the subnet 106 belongs to the same IP subnet. For example, the host 104, the server cluster 108, and the cluster members may all belong to the same IP subnet “9.37.38”, as shown.

After the load balancing node 112 receives the initial message 202 from the host 104, the load balancing node 112 selects a target server 206 to receive the initial message 202. In most applications, the load balancing node 112 selects the target server 206 based on loading considerations, however the present invention is not limited to such a selection criteria. Once the target server 206 is selected, the load balancing node 112 forwards the message 207 to the target server 206. Note that any message from server 206 to host 104 bypasses the load balancing node 112 and goes directly to 104, as indicated by message 209.

After forwarding the initial message to the target server 206, the load balancing node 112 sends an instructing message 210 to the host 104. In one embodiment of the invention, the load balancing node 112 sends the instructing message 210 only if the host 104 is in the same subnet as the IP address of the server cluster 108. This is easy to check since the source IP address is available for both TCP and UDP protocols. The instructing message 210 requests that the host 104 modify its network mapping such that future messages 212 sent by the host 104 to the server cluster 108 reach the target server 206 without passing through the load balancing node 112. This is done by either telling the host that it is taking a different route to the destination, or by mapping the cluster IP address to a different physical network address. By doing so, messages from the host 104 that would normally be forwarded to the target server 206 using the load balancing node 112 arrive at the target server 206 directly. Thus, bottlenecks at the load balancing node 112 due to large inbound messages can be substantially reduced using the present invention.

It is contemplated that the instructing message 210 may be any message known to those skilled in the art for modifying the host's network mapping. Thus, the content of the instructing message 210 is implementation dependent and can vary depending on the protocol used by the present invention. In one embodiment of the invention, for example, an ICMP_REDIRECT message can be used to request the network mapping change. In another embodiment, an ARP response message can be used to request the network mapping change when host 104 sends an ARP broadcast requesting an IP-address-to-MAC-address mapping for the cluster IP address. More information about ICMP and ARP protocols can be found in, Internetworking with TPC/IP Vol.1: Principles, Protocols, and Architecture (4th Edition), by Douglas Comer, ISBN 0130183806. While each technique has unique implementation aspects, their end result is that whenever the host 104 sends another packet to the primary cluster IP address 204, it is directed to the target server 206 without passing through the load balancing node 112.

In addition to sending the instructing message 210, the load balancing node 112 can optionally send a control message 208 to the load balancer agent running on the target server 206 after the initial message is forwarded to the target server 206. For example, if UDP is being used as the underlying transport protocol, then the tracking of the timeout for inactivity of UDP traffic to the configured port, which would cause traffic from the host 104 to the target server 206 to once again be directed through the load balancing node 112, has to be performed by the target server 206 since the load balancing node 112 is unable to monitor that traffic. The target server 206 therefore has to be aware of the timeout configured in the load balancing node 112. Note that while the server 206 is aware of the timeout configured in the load balancing node 112, it can choose to implement a higher timeout, if based on its analysis of response times when communicating with the host, it concludes that the host's path to it is slower than expected.

Once the communication session between the host 104 and target server 206 is completed, the host's network mapping is returned to its original state so that future load balancing by the load balancing node 112 can be performed. In one embodiment of the invention, a completed communication session is defined as the point when the total connections between the host 104 and the target server 206 is zero in a stateful protocol (such as TCP), and the point after a specified period of inactivity between the host 104 and the target server 206 in a stateless protocol (such as UDP). Thus, upon completion of the communication session (i.e., a decision by the target server 206 to terminate the special affinity relationship between the host 104 and itself), the target server 206 sends a control message 214 to the load balancing node 112, and the load balancing node 112 sends an instructing message 216 to the host 104 to modify its network mapping table. This instructing message 216 requests that the host 104 modify its network mapping again so that messages sent to the server cluster 108 stop being routed directly to the target server 206 and instead travel to the load balancing node 112.

FIG. 2 also includes a second cluster IP address 218. This address is used in another embodiment of the invention that uses the ICMP_REDIRECT method when redirecting the host back to the load balancer node.

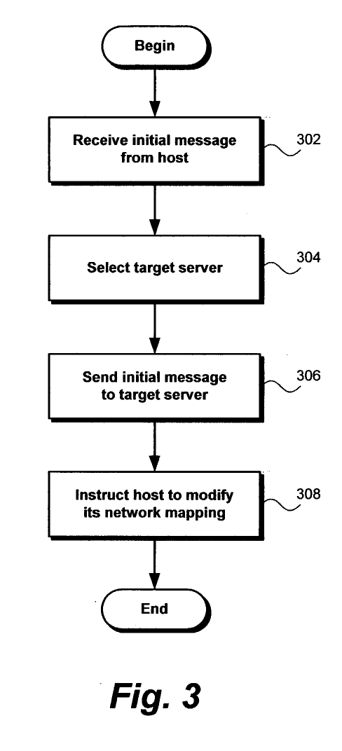

In FIG. 3, a flowchart showing some of the operations performed by one embodiment of the present invention is presented. It should be remarked that the logical operations of the invention may be implemented (1) as a sequence of computer executed steps running on a computing system and/or (2) as interconnected machine modules within the computing system. The implementation is a matter of choice dependent on the performance requirements of the system implementing the invention. Accordingly, the logical operations making up the embodiments of the present invention described herein are referred to alternatively as operations, steps, or modules.

Operation flow begins with receiving operation 302, wherein the load balancing node receives an initial message from the host. As mentioned above, the initial message is typically sent to a server cluster's virtual network address and is routed to the load balancing node by means of address mapping. In a particular configuration of the invention, different IP addresses are used to access different server cluster services. For example, the cluster's NFS file service would have one server cluster IP address, while the cluster's CIFS file service would have another server cluster IP address. This arrangement avoids redirecting all the traffic from a host for the cluster's services to the target server when only one service redirection is intended.

In some real-world configurations the server cluster may have only one cluster-wide virtual IP address and different ports (TCP or UDP) are used to identify different services (e.g., NFS, CIFS, etc.). Since the present invention works at the granularity of an IP address, implementation of the invention may require that different cluster IP addresses be assigned for different services. Thus, a given host can be assigned to one server in the cluster for one service, and a different server in the cluster for a different service, based on the destination (TCP or UDP) port numbers. After the receiving operation 302 is completed, control passes to selecting operation 304.

At selecting operation 304, the load balancing node selects one of the cluster members as a target server responsible for performing tasks requested by the host. As mentioned above, the load balancing node may select the target server for any reason. Most often, the target server will be selected for load balancing reasons. The load balancing node typically maintains a connection table to keep track of which cluster member was assigned to handle which network session. In a particular embodiment of the invention, the load balancing node maintains connection table entries for TCP connections, and maintains affinity (virtual connections) table entries for UDP datagrams. Thus, in the general load balancing function, all UDP datagrams with a given (src IP address, src port) and (destination IP address, destination port) are directed to the same target server in the cluster until some defined time period of inactivity between the host and the server cluster expires.

During selecting operation 304, the load balancing node may also decide whether or not to initiate direct server routing according to the present invention. Thus, it is contemplated that the load balancing node may selectively initiate direct message routing on a case-by-case basis based on anticipated inbound message sizes from the host or other factors. For example, the load balancing node may implement conventional server cluster functionality for communication sessions with relatively small inbound messages (e.g., HTTP requests for Web page serving). On the other hand, the load balancing node may implement direct message routing for communication sessions with relatively large inbound messages (e.g., file serving using NFS or CIFS). Such decision making is facilitated by the fact that when the underlying transport protocol is TCP or UDP, well-known (TCP or UDP) port numbers can be used to identify the underlying application being accessed over the network.

Once the selecting operation 304 is completed, the load balancing node then forwards the initial message to the target server during sending operation 306. The initial message may be directed to the target server by only changing the LAN (Local Area Network) level MAC (Media Access Control) address of the message. The selecting operation 304 may also include creating a connection table entry for that load balancing node. After the sending operation 304 is completed, control passes to instructing operation 308.

At instructing operation 308, the load balancing node instructs the host to modify its routing table so that future messages from the host arrive at the target server without first passing through the load balancing node. Once the host updates its routing table, the load balancing node is no longer required to forward messages to the target server from the host. It is contemplated that the load balancing node may update its connection table to flag the fact that routing modification on the host has been requested. It should be noted that if the host does not modify its routing table as requested by the load balancing node, the server cluster simply continues to function in a conventional manner without the benefit of direct message routing.

Once affinity between the host and the target server is established, direct communications between these nodes continues until the network session is completed. What constitutes a completed network session may be dependent on the specific mechanism used to implement the present invention. For example, in one embodiment of the invention, the network session is considered completed after a specified period of inactivity between the host and the target server, when a stateless protocol such as UDP is used. In other embodiments of the invention, completion of the network session may occur when a connection count between the host and the target server goes to zero, when a stateful protocol such as TCP is used.

As mentioned above, the host's network mapping is returned to its original configuration after the communication session is completed. Generally speaking, this procedure involves reversing the mapping operations above. Thus, when the communication session is finished, the target server sends a control message to the load balancer to inform it that the session is being terminated. In response, the load balancer sends an instructing message to the host requesting that the host modify its network mapping again such that messages sent to the server cluster stop being routed directly to the target server and instead travel to the server cluster and thus the load balancing node.

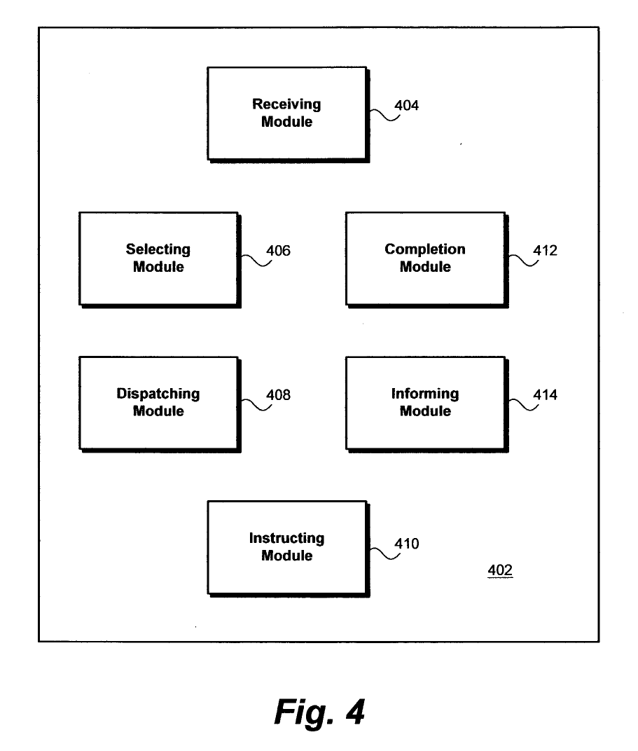

In FIG. 4, an exemplary system 402 implementing the present invention is shown. The system 402 includes a receiving module 404 configured to receive network messages from the host at the load balancing node. A selecting module 404 is configured to select the target server to receive the network messages from the host. A dispatching module 408 is configured to dispatch the network messages to the target server. An instructing module 410 is configured to instruct the host to modify its network mapping such that future messages sent by the host to the server cluster reach the target server without passing through the load balancing node.

The system 402 may also include a session completion module 412 and an informing module 414. The session completion module 412 is configured to instruct the host to modify its network mapping from the target server to the server cluster after a communication session between the host and the target server is completed. The informing module 414 is configured to inform the load balancing node that the communication session between the host and the target server should be completed.

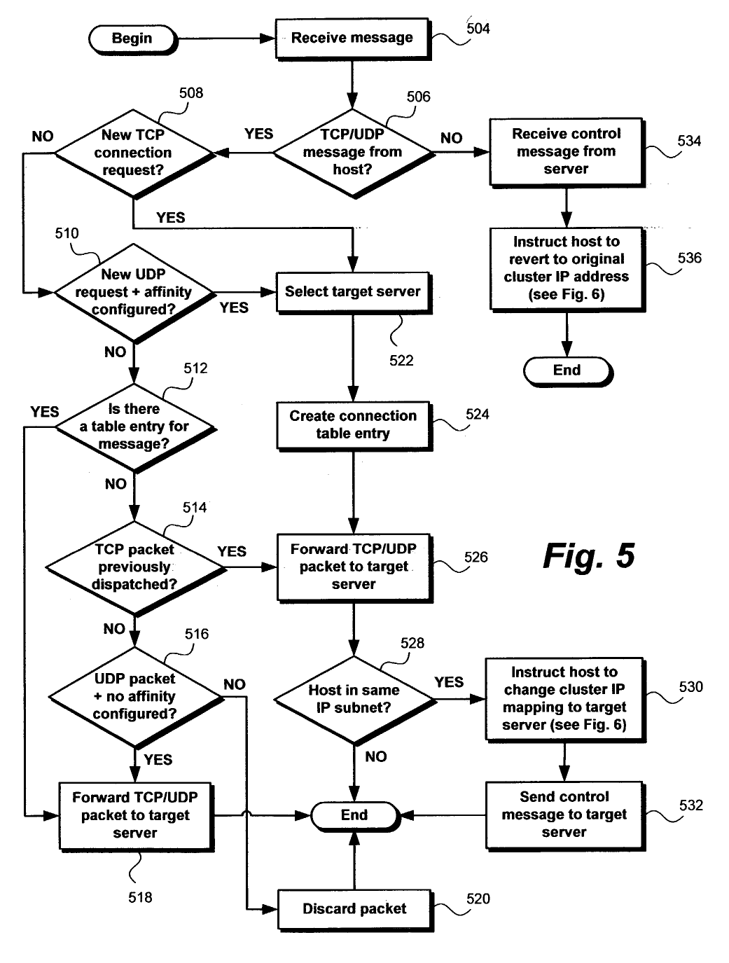

In FIG. 5, a flowchart for the processing logic in the load balancing node is shown. As stated above, the logical operations of the invention may be implemented (1) as a sequence of computer executed steps running on a computing system and/or (2) as interconnected machine modules within the computing system. Accordingly, the logical operations making up the embodiments of the present invention described herein are referred to alternatively as operations, steps, or modules.

Operation flow begins with the receiving operation 504, wherein the load balancing node receives an inbound message. Once the message is received, control passes to decision operation 506, where the load balancing node checks whether the message is a TCP or UDP packet from a host or a control message from a server in the cluster. The load balancing node can distinguish the control messages from servers in the cluster from the “application” messages from hosts outside the cluster based on the TCP or UDP port it receives the message on. Furthermore, messages from hosts outside the cluster are sent on the cluster-wide (virtual) IP address, whereas control messages from servers in the cluster (running load balancing node agents) are sent to a different IP address.

If the message is from a host outside the cluster, control proceeds to query operation 508. During this operation, the message is checked to determine if it is an initial message from a host in the form of a TCP connection setup request or not. If the message is a TCP connection setup request to the cluster IP address, control passes to selecting operation 522. If the message is not a TCP connection setup request, as determined by query operation 508, control proceeds to decision operation 510.

At decision operation 510, a check is made to determine if the message is a new UDP request between a pair of IP addresses and ports. In other words, decision operation 510 checks whether no connection table entry exists for this source and destination IP address pair and target port, and whether affinity for UDP packets is configured for the target port. In decision operation 510, if the request received is a UDP datagram for a given target port (service) for which no affinity exists and affinity is to be maintained (decision yields YES), then it too is an initial message and control passes to selecting operation 522. If the decision yields a value of NO, then control proceeds to decision operation 512.

At decision operation 512, a check is made to determine if a connection table already exists for the TCP or UDP packet in the form of a table entry whose key is <source IP address, target (cluster) IP address, target port number>. This entry indicates an affinity relationship between a source application on a host, and a target application running in every server in the cluster. The connection table entry exists for TCP as well as UDP packets, but the latter will only exist if UDP affinity is configured for the target port (application, e.g., the NFS well-known ports). Control comes to decision operation 512 if the load balancing node is operating in “legacy mode”. Legacy mode operation would occur if, for example, the host is not on the same subnet, the host's mapping table cannot be changed, or the ICMP technique (described later) is being used to change the host's mapping table but the host is ignoring the ICMP_REDIRECT message. If, at decision operation 512, it is determined that a connection table entry does exist for the packet, control proceeds to forwarding operation 518. If a connection table entry does not exist, control proceeds to decision operation 514.

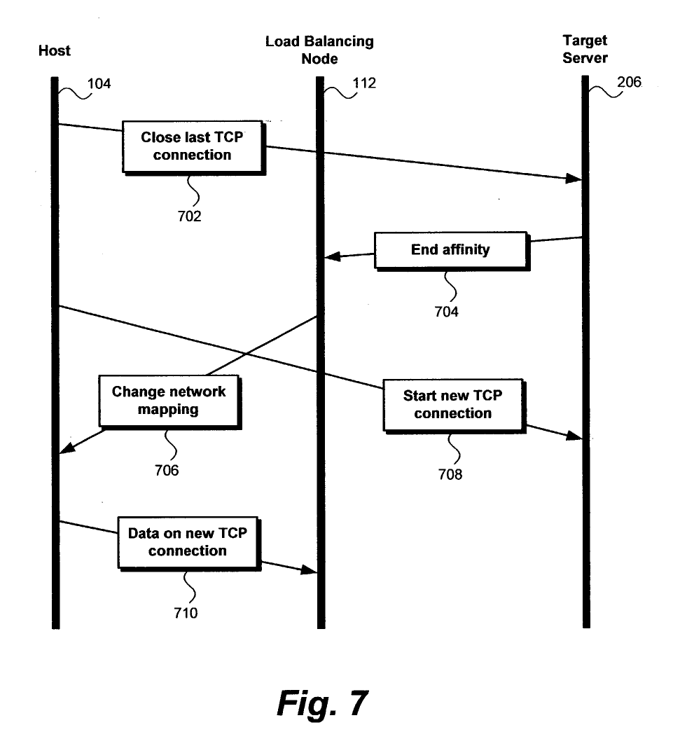

Decision operation 514 addresses a “race condition” that may occur during operation of the invention. To illustrate the race condition that may occur, reference is now made to FIG. 7. As shown, the host 104 sends a close message 702 to the target server 206 terminating its last TCP connection. Upon receipt of the close message 702, the target server 206 sends an end affinity message 704 to the load balancing node 112 requesting that the current target server redirection be terminated. In response, the load balancing node 112 sends a mapping table changing command 706 to the host requesting that future TCP packets to the cluster IP address be routed to the load balancing node 112 rather than the target server 206. However, before the mapping table changing command 706 reaches the host 104, a new TCP connection 708 is sent from the host 104 to the target server 206. Furthermore, once the mapping table changing command 706 is processed by the host 104, data 710 on the new TCP connection is sent to load balancing node 112. Thus, the race condition causes traffic on the new TCP connection to split between the load balancing node 112 and the target server 206.

To handle this race condition, the target server 206 informs the load balancing node 112 of the fact that the session has ended, and the load balancing node 112 issues the mapping table changing command 706 to the host 104, being fully prepared for the race condition to occur. Since the load balancing node 112 is prepared for the race condition, when it receives TCP traffic from the host 104 for which no connection table entry exists, it could keep operating in “legacy” mode by creating a connection table entry and sending another mapping table changing command 706 that directs the host 104 back to the target server 206.

Returning to FIG. 5, at decision operation 512, once the target server notes that the number of connections from the host have dropped to 0 (zero), it sends a control message (see identifying operation 534 where the control message is received by the load balancing node) to the load balancing node to indicate that it can send another mapping table changing message to the host such that future TCP or UDP requests to the cluster go through the load balancing node once more, thus allowing load balancing decisions to be taken again. However, as described above, due to the nature of networking and multiple nodes (host, server, load balancing node) operating independently, it is possible that before the load balancing node receives the control message from the server and decides to send a mapping table changing command to the host (see instructing operation 536), the host has already sent another new TCP connection request directly to the assigned server based on its old mapping table (possibly to a different port), and thus there is no mapping table entry for that <source IP address, destination IP address, target port> key in the load balancing node. However, later when the load balancing node executes instructing operation 536 and directs the host to send it IP packets intended for the cluster IP address, it ends up getting packets on this new TCP connection without having seen the TCP connection request.

Thus, decision operation 514 ensures that this possible sequence of events is accounted for. The load balancing node prepares for this possibility in identifying operation 534. If the load balancing node encounters this condition in decision operation 514 (the decision yields the value YES), it understands that it must switch the host's connection table back to the assigned server, and control proceeds to forwarding operation 526. However, if the decision of operation 514 yields the value NO, then control proceeds to decision operation 516.

Control reaches decision operation 516 if the load balancing node receives a TCP or UDP packet with a given <source IP address, destination IP address, destination port> key for which no connection table exists. This situation is only valid if it is a UDP packet for which no affinity has been configured for the target port (application). In this (UDP) case, if a previous UDP packet from that host was received to a different target port, and affinity was configured for that port, and the load balancer used one of the two methods to direct the host to a specific server in the cluster, then even for this target port, the load balancer must enforce affinity to the same server in the cluster, even if affinity was not configured. This is another race condition that the load balancer must deal with, because once the ICMP_REDIRECT or ARP method alters the affinity table on the host, all UDP packets from that host to any target port will be directed to the specific server in the cluster, and this race condition indicates a scenario where the ICMP REDIRECT or ARP response has simply not completed its desired side effect in the host yet. If no affinity has been configured for the target port, then a target server needs to be selected to handle this particular (stateless) request, and control passes from decision operation 516 to forwarding operation 518. Otherwise, this is a TCP packet, no connection table entry exists, and a packet from the same source node (host) was not previously dispatched to a server in the cluster (the condition of decision operation 514). Thus, this is an invalid packet and control proceeds to discarding operation 520 where the packet is discarded.

Returning to forwarding operation 518, packet forwarding takes place for a TCP or UDP packet in “legacy” mode, where the invention techniques are either not applicable because the host is in a different subnet, or the technique is not functioning because of the host implementation (e.g., the host is ignoring ICMP_REDIRECT messages). In this case, the target server is chosen based on the connection table entry if control reaches the forwarding operation 518 from decision operation 512, or based on some other load balancing node policy (e.g., round robin, or currently least loaded server as indicated by the load balancing node agent on that server) if control reaches here from decision operation 516.

Referring again to selecting operation 522, which is reached from operations 508 or 510, a target server is selected based on load balancing node policy (currently least loaded server, round-robin, etc.). This operation is the point where the invention technique might be applicable and an “initial message”, either TCP or UDP, has been received. After selecting operation 522 is completed, control passes to generating operation 524. During generating operation 524, a connection table entry is recorded to reflect the affinity between the (source) host and (destination) server in the cluster, for a given port (application). The need for the port as part of the affinity mapping is legacy load balancing node behavior. After generating operation 524 is completed, control passes to forwarding operation 526. In forwarding operation 526, the packet (TCP connection request, or UDP packet) is forwarded to the selected server. Control then proceeds to decision operation 528.

At decision operation 528, a check is made to see if the host (as determined by the source IP address) is in the same IP subnet. If the host is in the same IP subnet, the invention technique can be applied and control proceeds to instructing operation 530. If the host is not in the IP subnet, processing ends. It should be noted that in some configurations, even if the host is on the same subnet, the load balancer may choose not to use the optimization of the present invention based, for example, on a configured policy and a target port as mentioned above.

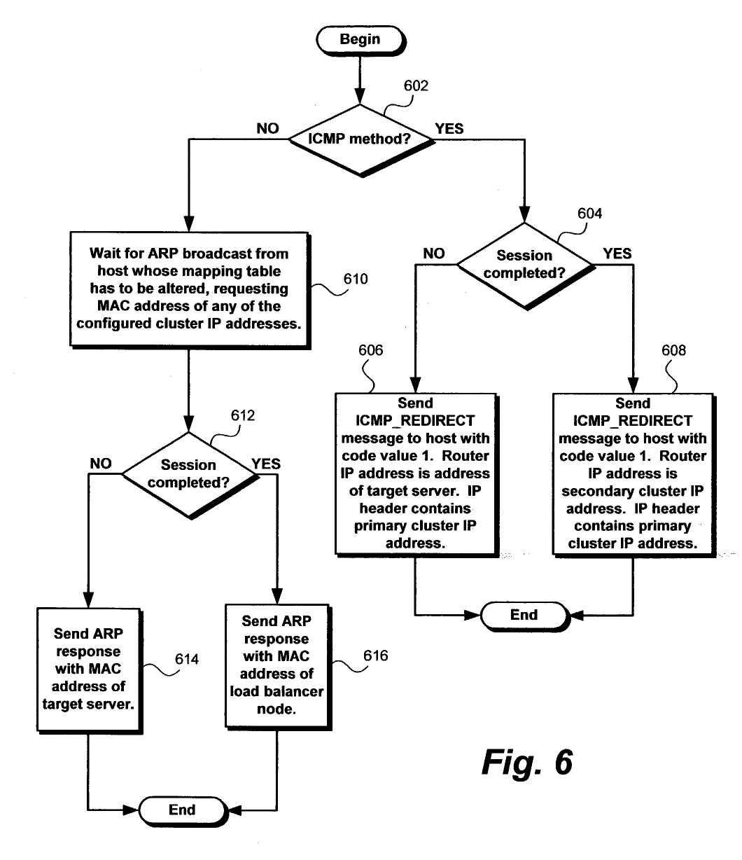

At instructing operation 530, the host is instructed to change how a packet from the host, intended for a given destination IP address, is sent to another machine on the IP network. After the instructing operation 530 completes, control proceeds to sending operation 532. Details of instructing operation 530 are shown in FIG. 6.

In sending operation 532, a control message is sent from the load balancing node to the server to which the TCP or UDP initial message was just sent, to tell the load balancing node agent on that node that the redirection has occurred. The sending operation 532 also indicates that the load balancing node agent should monitor operating conditions to determine when it should switch control back to the load balancing node. One example of such monitoring would be involved if a TCP connection is dispatched to it from a given host. Due to the host mapping table change, the server will not only directly receive further TCP packets from that host, bypassing the load balancing node, but it could also receive new TCP connection requests. For example, certain implementations of a service protocol can set up multiple TCP connections for reliability, bandwidth utilization, etc. In that case, the load balancing node tells the agent on that server to switch control back when the number of TCP connections from that host goes to 0 (zero). For UDP packets forwarded to the server where affinity is configured, the load balancing node tells the server to monitor inactivity between the host and server, and when the inactivity timeout configured in the load balancing node is observed in the server, it should pass control back to the load balancing node. Note that while the server is aware of the timeout configured in the load balancing node, it can choose to implement a higher timeout, if based on its analysis of response times when communicating with the host, it concludes that the host's path to it is slower than expected.

In receiving operation 534, the load balancing node receives a message from a server in the cluster (from the load balancing agent running on that server) indicating that the server is giving control back to the load balancing node (because the number of TCP connections from that host is down to 0 (zero) or because of UDP traffic inactivity). Control then proceeds to sending operation 536.

At sending operation 536, the load balancing node sends a message to the host to revert its network mapping tables back to the original state such that all messages sent from that host to the cluster IP address once again are sent to the load balancing node, essentially reverting the host state back to what existed before instructing operation 530 was executed. Once the sending operation 536 is completed, the process ends. Details of instructing operation 536 are shown in FIG. 6.

FIG. 6 shows details of operations 530 and 536 of FIG. 5, as applicable to both the ARP broadcast method and the ICMP_REDIRECT method described above. The process begins at decision operation 602. During this operation, the load balancing node determines whether or not the ICMP_REDIRECT method can be used. It is envisioned that ICMP_REDIRECT method can be selected by a system administrator or by testing whether the host responds to ICMP_REDIRECT commands. If the ICMP_REDIRECT method is used, control passes to query operation 604.

During query operation 604, the process determines whether the host-to-cluster session has completed (see operation 536 of FIG. 5), or if this is a new host-to-cluster session being set up (see operation 530 of FIG. 5). If query operation 604 determines that the host-cluster session has not completed, control passes to sending operation 606.

At sending operation 606, the host is instructed to modify its IP routing table using ICMP_REDIRECT messages. The format of an ICMP_REDIRECT message is shown in Table 1. The ICMP_REDIRECT works by redirecting the IP traffic to the next hop, in effect telling it to take a different route. Normally, for the purposes of the ICMP_REDIRECT, the target server is the router. In this embodiment, an ICMP_REDIRECT message with code value 1 instructs the host to change its routing table such that whenever it sends an IP datagram to the server cluster (virtual) IP address, it will send it to the target server instead. In the ICMP_REDIRECT message, the router IP address is the address of the target server address selected by the load balancing node. The “IP header+first . . . ” field contains the header of an IP datagram whose target IP address is the primary virtual cluster IP address. As mentioned above, in the event that the host ignores the ICMP_REDIRECT message, the server cluster will continue to operate in a conventional fashion.

TABLE 1
Format of ICMP_REDIRECT Packet

| | | |
|---|---|---|
| Type (5) | Code (0 to 3) | Checksum |

Router IP address
IP header + first 64 bits of datagram
. . .

For inbound UDP (User Datagram Protocol) messages, the load balancing node can direct the first UDP datagram from the host to the target server, create a connection table entry based on <source IP address, destination IP address, destination port>, and then send the ICMP_REDIRECT message to the host, thus pointing the host to the target server IP address. Returning to FIG. 2, this redirect message would, for example, be of the form: Router IP address=9.37.38.32, IP datagram address=9.37.38.39. If the routing table is updated by the host 104, future datagrams from the host 104 to the server cluster IP address 204 will be sent to the target server 206 (IP address 9.37.38.32) directly, thus bypassing the load balancing node 112.

Referring back to query operation 604 of FIG. 6, if it is determined that the process is being executed because the host-to-cluster session has completed, control passes to sending operation 608. At sending operation 608, the host is instructed to modify its IP routing table using ICMP_REDIRECT messages such that whenever it sends an IP datagram to the target server, the message is sent to the server cluster IP instead. Thus, sending operation 608 reverses the effect of the ICMP_REDIRECT message issued in sending operation 606. The router IP address is an alternate cluster address as discussed below.

Returning to FIG. 2, when the UDP port affinity timer for the host 104 expires, as indicated by the control message from server 206 to the load balancing node 112, load balancing node 112 can send another ICMP_REDIRECT message to the host 104 pointing to the alternate server cluster IP address 218. Such an ICMP_REDIRECT message would, for example, be of the form: Router IP address=9.37.38.39, IP datagram address=9.37.38.40. This message would create a host routing table entry pointing one server cluster IP address to another (alternate) server cluster IP address. The alternate IP address enables host messages to reach the load balancing node 112 without causing a loop in the routing table of the host 104. Note that for the above technique to work, it is required that the server cluster have two virtual IP addresses, which is not uncommon.

For inbound TCP (Transmission Control Protocol) messages, the load balancing node 112 can create a connection table entry for the first TCP connection request from the host 104, forward the request to the target server 206, and send an ICMP_REDIRECT message to the host 104. The ICMP_REDIRECT message could, for example, be of the form: Router IP address=9.37.38.32, IP datagram address=9.37.38.39. Future TCP packets sent by the host 104 on that connection would be sent to the target server 206 (IP address 9.37.38.32) directly, bypassing the load balancing node 112.

With TCP, it is important to redirect the host 104 back to the load balancing node 112 when the total number of TCP connections between the host 104 and the target server 206 is zero. Since the load balancing node 112 does not see any inbound TCP packets after the first connection is established between the host 104 and the target server 206, information about when the connection count goes to zero must come from the target server 206. This can be achieved by adding code in the load balancing node agent that typically runs in each server (to report load, etc.), extending such an agent to monitor the number of TCP connections, or UDP traffic inactivity, in response to receiving control messages from the load balancing node as in step 532 in FIG. 5. Such load balancing node agent extensions can be implemented by using well known techniques for monitoring TCP/IP traffic on a given operating system, which typically involves writing kernel-layer “wedge” drivers (e.g., a TDI filter driver on Microsoft's Windows operating system) and sending control messages to the load balancing node in response to the conditions being observed. Windows is a registered trademark of Microsoft Corporation in the United States and other countries.

Returning to FIG. 6, if at query operation 604 it is determined that the ICMP_REDIRECT method is not being used, control passes to waiting operation 610.

At waiting operation 610, the process waits until an ARP broadcast message is issued from the host requesting the MAC address of any of the configured cluster IP addresses. During the waiting operation 610, messages from the host are sent to the server cluster, received by load balancing node, and then forwarded to the target server in a conventional matter until an ARP broadcast is received from the host to refresh the host's ARP cache. Once an ARP broadcast message is received from the host, control passes to query operation 612.

At query operation 612, the process determines whether the communication session between the host and the server cluster has ended. If the session has not ended, then a new host-to-cluster session is being set up, and control passes to sending operation 614.

At sending operation 614, the host is instructed to modify its ARP cache such that the MAC address associated with the cluster IP address is that of the target server instead of the MAC address of the load balancing node. Thus, in response to the ARP broadcast, the load balancing node returns the MAC address of the target server to the host rather than its own MAC address. As a result, subsequent UDP or TCP packets sent by the host to the cluster virtual IP address reach the target server, bypassing the load balancing node. It is contemplated that load-balancer-to-agent protocols may be needed for each server to report its MAC address to the load balancing node to which its IP address is bound.

If, at query operation 612, it is determined that the session between the host and cluster has ended, control passes to sending operation 616. During sending operation 616, the host is instructed to modify its ARP cache such that the MAC address associated with the cluster IP address is that of the load balancing node instead of the MAC address of the target server. Thus, sending operation 616 reverses the ARP cache modification message issued in sending operation 614.

Turning again to FIG. 2, The ARP-based embodiment requires another ARP broadcast from the host 104 for the cluster IP address to switch messages back to the load balancing node 112. Thus, once the number of TCP connections between the target server 206 and the host 104 goes to zero, the target server 206 notifies the load balancing node 112 about the opportunity to redirect the host 104 back to the load balancing node 112 as the destination for messages sent to the cluster IP address 204. The load balancing node 112 cannot redirect the host 104 until it receives the next ARP broadcast from the host 104 for the cluster IP address. When the ARP broadcast is received, the load balancing node 112 responds with its own MAC address, such that subsequent UDP or TCP packets from the host 104 reach the load balancing node 112 again.

The foregoing description of the invention has been presented for purposes of illustration and description. It is not intended to be exhaustive or to limit the invention to the precise form disclosed, and other modifications and variations may be possible in light of the above teachings. The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for managing network connectivity between a host and a target server, the target server belonging to a server cluster, and the server cluster including a dispatching node configured to dispatch network traffic to cluster members, the method comprising:
receiving an initial message from the host at the dispatching node;
selecting the target server to receive the initial message;
sending the initial message to the target server; and
instructing the host to modify its network mapping such that future messages sent by the host to the server cluster reach the target server without passing through the dispatching node.

2. The method of claim 1, wherein instructing the host to modify its network mapping includes directing the host to modify its address lookup table.

3. The method of claim 1, wherein instructing the host to modify its network mapping includes adding a redirect rule to a host's IP (Internet Protocol) routing table such that any message sent by the host to the server cluster is instead sent to the target server.

4. The method of claim 1, wherein instructing the host to modify its network mapping includes directing the host to modify its ARP (Address Resolution Protocol) cache such that the target server's. Mac (media access control) address is substituted for the server cluster's mac address when sending an ip datagram to the server cluster.

5. The method of claim 1, further comprising instructing the host to modify its network mapping from the target server to the server cluster after a communication session between the host and the target server is completed.

6. The method of claim 5, further comprising informing the dispatching node that the communication session (or the affinity relationship) between the host and the target server is completed.

7. The method of claim 1, further comprising instructing the host to modify its network mapping from the target server to the server cluster after an affinity relationship is terminated based on dispatching node configuration when a stateless protocol is used.

8. The method of claim 7, further comprising informing the dispatching node that the affinity relationship between the host and the target server is completed.

9. A system for managing network connectivity between a host and a target server, the target server belonging to a server cluster, and the server cluster including a dispatching node configured to dispatch network traffic to cluster members, the system comprising:
a receiving module configured to receive network messages from the host at the dispatching node;
a selecting module configured to select the target server to receive the network messages from the host;
a dispatching module configured to dispatch the network messages to the target server; and
an instructing module configured to instruct the host to modify its network mapping such that future messages sent by the host to the server cluster reach the target server without passing through the dispatching node.

10. The system of claim 9, wherein the instructing module is further configured to direct the host to modify its address lookup table.

11. The system of claim 9, wherein the instructing module is further configured to add a redirect rule to a host's IP (Internet Protocol) routing table such that any message sent by the host to the server cluster is instead sent to the target server.

12. The system of claim 9, wherein the instructing module is further configured to direct the host to modify its ARP (Address Resolution Protocol) cache such that the target server's MAC (Media Access Control) address is substituted for the server cluster's MAC address when sending an IP datagram to the server cluster.

13. The system of claim 9, further comprising a session completion module configured to instruct the host to modify its network mapping from the target server to the server cluster after a communication session between the host and the target server is completed.

14. The system of claim 13, further comprising an informing module configured to inform the dispatching node that the communication session between the host and the target server is completed.

15. The system of claim 9, further comprising a session completion module configured to instruct the host to modify its network mapping from the target server to the server cluster after an affinity relationship is to be terminated based on dispatching node configuration.

16. The system of claim 13, further comprising an informing module configured to inform the dispatching node that the affinity relationship is to be terminated based on dispatching node configuration.

17. A computer program product embodied in a tangible media comprising:
computer readable program codes coupled to the tangible media for managing network connectivity between a host and a target server, the target server belonging to a server cluster, and the server cluster including a dispatching node configured to dispatch network traffic to cluster members, the computer readable program codes configured to cause the program to:
receive an initial message from the host at the dispatching node;
select the target server to receive the initial message;
send the initial message to the target server; and
instruct the host to modify its network mapping such that future messages sent by the host to the server cluster reach the target server without passing through the dispatching node.

18. The computer program product of claim 17, wherein instructing the host to modify its network mapping includes directing the host to modify its address lookup table.

19. The computer program product of claim 17, wherein the computer readable program code configured to instruct the host to modify its network mapping is further configured to add a redirect rule to a host's IP (Internet Protocol) routing table such that any message sent by the host to the server cluster is instead sent to the target server.

20. The computer program product of claim 17, wherein the computer readable program code configured to instruct the host to modify its network mapping is further configured to direct the host to modify its ARP (Address Resolution Protocol) table such that the target server's MAC (Media Access Control) address is substituted for the server cluster's MAC address.

21. The computer program product of claim 17, further comprising computer readable program code configured to instruct the host to modify its network mapping from the target server to the server cluster after a communication session between the host and the target server is completed.

22. The computer program product of claim 21, further comprising computer readable program code configured to inform the dispatching node that the communication session between the host and the target server is completed.

23. A system for managing network connectivity between a host and a target server, the target server belonging to a server cluster, and the server cluster including a dispatching node configured to dispatch network traffic to cluster members, the system comprising:
means for receiving an initial message from the host at the dispatching node;
means for selecting the target server to receive the initial message;
means for sending the initial message to the target server; and
means for instructing the host to modify its network mapping such that future messages sent by the host to the server cluster reach the target server without passing through the dispatching node.
